(19) United States
(12) Patent Application Publication
(10) Pub. No.: US 2024/0202681 A1
(43) Pub. Date: Jun. 20, 2024

(54) SYSTEM, METHOD, AND COMPUTER PROFRAM FOR BILL MANAGEMENT USING VIRTUAL ACCOUNTS

(71) Applicant: RAKUTEN SYMPHONY SINGAPORE PTE. LTD., Singapore (SG)

(72) Inventor: Mayur KACHHADIYA, Indore (IN)

(73) Assignee: RAKUTEN SYMPHONY SINGAPORE PTE. LTD., Singapore (SG)

(21) Appl. No.: 17/802,586

(22) PCT Filed: Jun. 27, 2022
(86) PCT No.: PCT/US2022/035057

§ 371 Date: Jan. 4, 2024

(51) Int. Cl. G06Q 20/10

(52) U.S. Cl. CPC G06Q 20/102

(57) ABSTRACT

A method for bill management of a business to business (B2B) customer account including one or more billing accounts, performed by at least one processor, is provided. The method includes receiving information on a plurality of virtual accounts linked to a bank account of a service provider, assigning a billing account, of a customer of the service provider, to a virtual account among the plurality of virtual accounts, receiving a notification of a payment made via the virtual account, identifying the billing account, from among the one or more billing accounts, assigned to the virtual account, and crediting the identified billing account for the payment.

### 1. FIELD

Apparatuses and methods consistent with example embodiments of the present disclosure relate to Business-to-Business (B2B) customer bill management, and more particularly B2B customer bill management using virtual bank accounts.

### 2. DESCRIPTION OF RELATED ART

Related art bill management of business to business (B2B) customers is complex, particularly when the number of customers and the amount of bills involved are significant. For example, when multiple B2B customers are paying a bill to a telecommunications service provider (or telco operator), each B2B customer will be given a bank account associated with the telco operator for making payments (e.g., via check, online remittance, etc.). The bank account provided to each of the B2B customers is the same bank account designated for all payments/remittances of the corresponding B2B customer. Thus, management of the billing/crediting, etc., of the bank account (e.g., regular audit, etc.) will be complicated and may cause delays in the crediting process.

Further, in the related art, when the B2B customers make payments, many manual steps are required. For example, customers typically need to manually deposit a check to the bank. Subsequently, the bank will need to confirm the payment, prepare a report (including details such as payment amount, payment date, check details, etc.) and send the report to the telco operator. The telco operator will review the report and credit the payment to the billing account of the B2B customer. If any errors occur in the report provided by the bank, the telco operator will send the report back to the bank to be revised. After the revision, the report is sent back to the telco operator. This process is time consuming and inefficient for bill payment, particularly when the payment is for urgent matters (e.g., last day of payment before due date).

Accordingly, there is a possibility that the payment does not timely complete due to human errors or operational delays. In such a case, the services provided to the associated B2B customers will be suspended even though the customer already made the payment. This will in turn result in bad customer experiences.

### SUMMARY

According to embodiments, systems and methods are provided for the purpose of bill management, wherein one or more virtual bank accounts dedicated to a B2B customer are utilized.

According to embodiments, a method for business to business (B2B) customer account comprising one or more billing accounts, performed by at least one processor of a computing device, includes: receiving information on a plurality of virtual accounts linked to a bank account of a service provider; assigning a billing account, of a customer of the service provider, to a virtual account among the plurality of virtual accounts; receiving a notification of a payment made via the virtual account; identifying the billing account, from among the one or more billing accounts, assigned to the virtual account; and crediting the identified billing account for the payment.

The method may further include transmitting an acknowledgment indicating at least one of a payment successfully received or a payment credited to a billing account.

The method may further include storing a status of each of the plurality of virtual accounts, the status being at least one of assigned or not assigned.

The method may further include obtaining a total balance of the billing account and crediting the billing account by updating the total balance based on the payment.

The method may further include receiving a payment report indicating payments made to the plurality of virtual accounts, amounts of the payments, and dates the payments were received.

The method may further include generating a bill report indicating a billing cycle, billing year, billing month, and bill amount corresponding to the billing account.

The method may further include wherein the notification includes at least a payment amount of the payment and an identification corresponding to the virtual account.

According to embodiments, an apparatus for bill management of a business to business (B2B) customer account comprising one or more billing accounts includes a memory storage storing computer-executable instructions and a processor communicatively coupled to the memory storage. The processor is configured to execute the computer-executable instructions and cause the apparatus to: receive information on a plurality of virtual accounts linked to a bank account of a service provider; assign a billing account, of a customer of the service provider, to a virtual account among the plurality of virtual accounts; receive a notification of a payment made the virtual account; identify the billing account, from among the one or more billing accounts, assigned to the virtual account; and credit the identified billing account for the payment.

The apparatus may further include wherein the at least one processor is configured to read the program code and operate as instructed by the program code to transmit an acknowledgment indicating at least one of payment information successfully received, via the notification, or a payment credited to a billing account.

The apparatus may further include wherein the at least one processor is configured to read the program code and operate as instructed by the program code to store a status of each of the plurality of virtual accounts, the status being at least one of assigned or not assigned.

The apparatus may further include wherein the at least one processor is configured to read the program code and operate as instructed by the program code to obtain a total balance of the billing account and credit the billing account by updating the total balance based on the payment.

The apparatus may further include wherein the at least one processor is configured to read the program code and operate as instructed by the program code to receive a payment report indicating payments made to the plurality of virtual accounts, amounts of the payments, and dates the payments were received.

The apparatus may further include wherein the at least one processor is configured to read the program code and operate as instructed by the program code to generate a bill report indicating a billing cycle, billing year, billing month, and bill amount corresponding to the billing account.

The apparatus may further include wherein the notification includes at least a payment amount of the payment and an identification corresponding to the virtual account.

According to embodiments, a non-transitory computer readable medium storing instructions that are executed by at least one processor of an apparatus for bill management of a business to business (B2B) customer account comprising one or more billing accounts. The instructions cause the at least one processor to: receive information on a plurality of virtual accounts linked to a bank account of a service provider; assign a billing account, of a customer of the service provider, to a virtual account among the plurality of virtual accounts; receive a notification of a payment made the virtual account; identify the billing account, from among the one or more billing accounts, assigned to the virtual account; and credit the identified billing account for the payment.

The non-transitory computer readable medium may further include wherein the instructions further cause the at least one processor to transmit an acknowledgment indicating at least one of payment information successfully received, via the notification, or a payment credited to a billing account.

The non-transitory computer readable medium may further include wherein the instructions further cause the at least one processor to store a status of each of the plurality of virtual accounts, the status being at least one of assigned or not assigned.

The non-transitory computer readable medium may further include wherein the instructions further cause the at least one processor to obtain a total balance of the billing account and credit the billing account by updating the total balance based on the payment.

The non-transitory computer readable medium may further include wherein the instructions further cause the at least one processor to receive a payment report indicating payments made to the plurality of virtual accounts, amounts of the payments, and dates the payments were received.

The non-transitory computer readable medium may further include wherein the instructions further cause the at least one processor to generate a bill report indicating a billing cycle, billing year, billing month, and bill amount corresponding to the billing account.

Additional embodiments will be set forth in the description that follows and, in part, will be apparent from the description, and/or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a flowchart of an example process utilized by a bill management system according to an embodiment;

FIG. 2 is a diagram of an example environment in which systems and/or methods, described herein, may be implemented;

FIG. 3 is a diagram of example components of a device according to an embodiment;

FIG. 4 illustrates a diagram of a bill management system according to an embodiment;

FIG. 5 is an illustration of virtual bank account and billing account associations according to embodiments;

FIG. 6 is a sequence diagram illustrating an example of a data flow according to embodiments;

FIG. 7 illustrates data flow according to embodiments;

FIG. 8A and FIG. 8B illustrate reports generated according to embodiments;

FIG. 9 is an exemplary flowchart illustrating a method for bill management according to an embodiment; and

FIG. 10 a block diagram of an example of computer code for bill management according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system for B2B bill payment and management. The method and system include multiple virtual bank accounts each of which are dedicated to B2B customers.

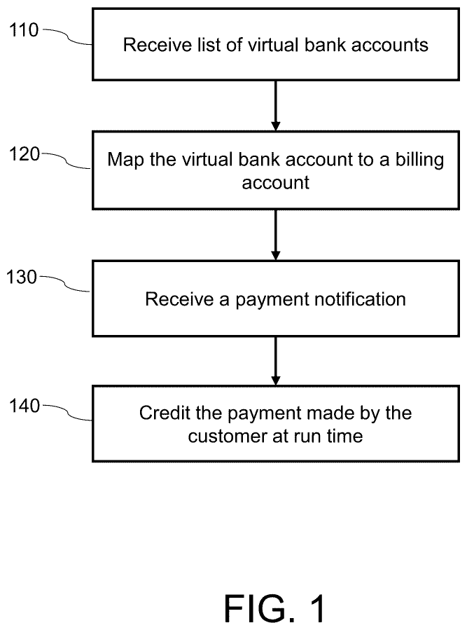

FIG. 1 a flowchart of an example process utilized by a bill management system according to embodiments. The system may include a service provider (hereafter “telco operator”), with one or more customers, in communication with a bank, banking system, or the like.

A set or list of virtual bank accounts may be created by the bank and allocated to the telco operator. At S110, the system receives the list of virtual bank accounts (or, for example, virtual bank account identification (ID) numbers) from the bank. Subsequently, each customer associated with the telco operator will be provided, by the telco operator, a unique virtual bank account. At S120, the virtual bank account is mapped to a billing account of the telco operator and for the customer. The billing account is the customer's account with the telco operator against which invoices are credited and debited.

To make a payment (e.g., after receiving a bill), the customer will make the payment (e.g., deposit a check) to the provided unique virtual bank account. Once the payment from the customer to the virtual bank account is received, the banking system may automatically generate a report of payment and send the report to the telco operator. As such, the system receives a notification indicating that payment to the virtual bank account is received (S130). At the same time, the bank system may also make an API call, e.g., to a Business Support System (BSS) of the telco operator so that the BSS may credit the payment to the telco operator's billing account at run time, wherein the billing account is subsequently credited (S140). Thus, the billing account is credited without waiting for review of a bank report by, e.g., an employee of the telco operator.

After receiving the bank report, the telco operator may use the report to check/confirm the accuracy of the credit in the billing account (if required), to compile a financial report, etc.

While FIG. 1 shows example operations of the process, in some implementations, the process may include additional operations, fewer operations, different operations, or differently arranged operations than those depicted in FIG. 1. Additionally, or alternatively, two or more of the operations of the process may be performed in parallel or combined.

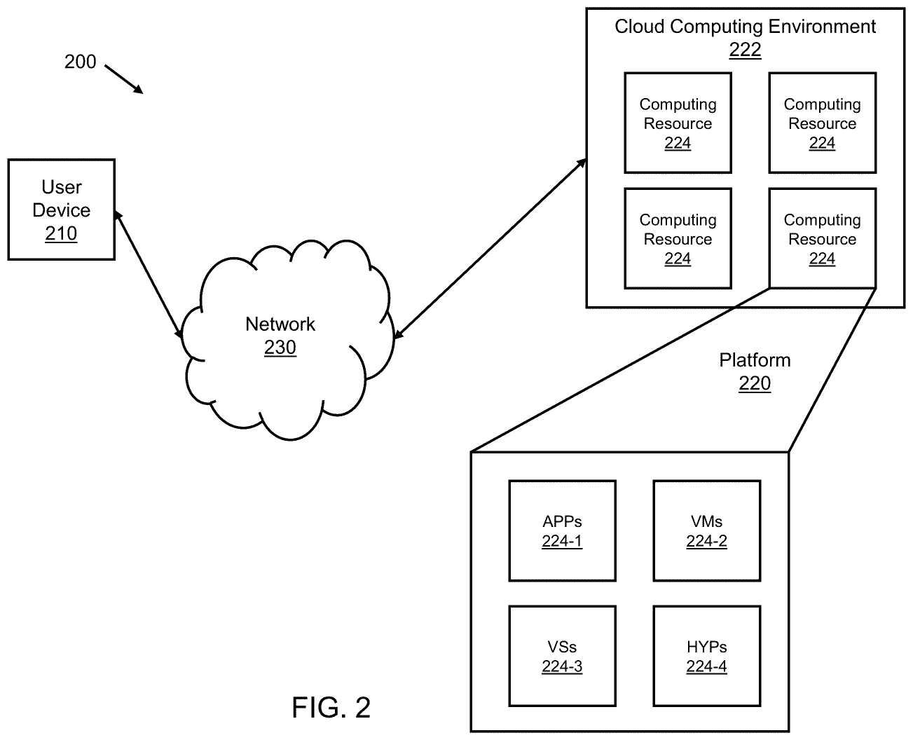

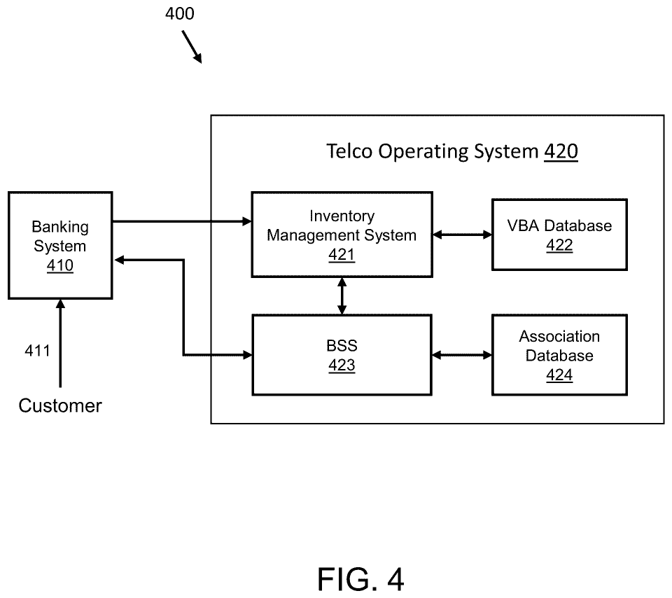

FIG. 2 is a diagram of an example environment 200 in which systems and/or methods, described herein, may be implemented. As shown in FIG. 2, environment 200 may include a user device 210, a platform 220, and a network 230. Devices of environment 200 may interconnect via wired connections, wireless connections, or a combination of wired and wireless connections. In embodiments, any of the functions and operations described with reference to FIG. 1 above (or FIGS. 4-10 below) may be performed by any combination of elements illustrated in FIG. 2.

User device 210 includes one or more devices capable of receiving, generating, storing, processing, and/or providing information associated with platform 220. For example, user device 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 210 may receive information from and/or transmit information to platform 220.

Platform 220 includes one or more devices capable of receiving, generating, storing, processing, and/or providing information. In some implementations, platform 220 may include a cloud server or a group of cloud servers. In some implementations, platform 220 may be designed to be modular such that certain software components may be swapped in or out depending on a particular need. As such, platform 220 may be easily and/or quickly reconfigured for different uses.

In some implementations, as shown, platform 220 may be hosted in cloud computing environment 222. Notably, while implementations described herein describe platform 220 as being hosted in cloud computing environment 222, in some implementations, platform 220 may not be cloud-based (i.e., may be implemented outside of a cloud computing environment) or may be partially cloud-based.

Cloud computing environment 222 includes an environment that hosts platform 220. Cloud computing environment 222 may provide computation, software, data access, storage, etc. services that do not require end-user (e.g., user device 210) knowledge of a physical location and configuration of system(s) and/or device(s) that hosts platform 220. As shown, cloud computing environment 222 may include a group of computing resources 224 (referred to collectively as “computing resources 224” and individually as “computing resource 224”).

Computing resource 224 includes one or more personal computers, a cluster of computing devices, workstation computers, server devices, or other types of computation and/or communication devices. In some implementations, computing resource 224 may host platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like.

Application 224-1 includes one or more software applications that may be provided to or accessed by user device 210. Application 224-1 may eliminate a need to install and execute the software applications on user device 210. For example, application 224-1 may include software associated with platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., user device 210), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

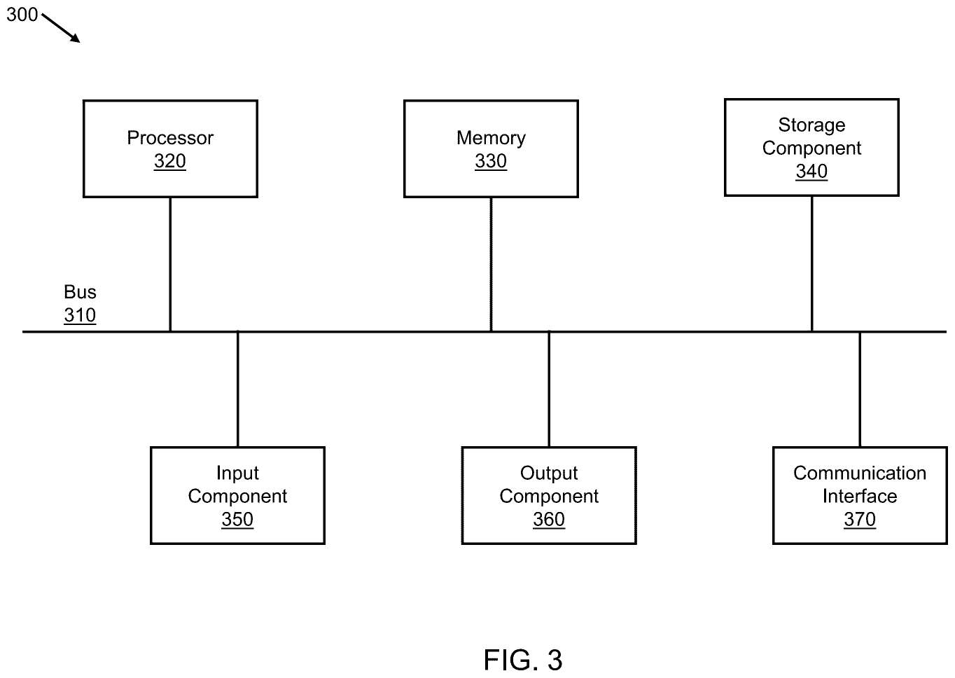

FIG. 3 is a diagram of example components of a device 300. Device 300 may correspond to user device 210 and/or platform 220. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 may be implemented in hardware, firmware, or a combination of hardware and software. Processor 320 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

In embodiments, any one of the operations or processes of FIGS. 1 and 4-10 may be implemented by or using any one of the elements illustrated in FIGS. 2 and 3.

FIG. 4 illustrates a diagram of a bill management system 400 in accordance with one or more embodiments. The bill management system 400 includes a banking system 410 and a telco operating system 420. Methods described in accordance with embodiments may be performed by one or more processors included in the telco operating system 420 configured to perform operations and/or read program code from at least one memory and operate as instructed by the program code. The telco operating system 420 includes an inventory management system 421, a virtual bank account (VBA) database 422, a Business Support System (BSS) 423, and an association database 424.

According to embodiments, each customer is assigned a billing account for receiving and applying payments towards, e.g., a service provided by an authorized user (e.g., telco operating system admin, etc.) of the telco operating system 420. A customer may have one or more billing accounts designated for different types of transactions, bills, provided services, etc.

The banking system 410 provides a list of virtual bank account (VBA) IDs to the inventory management system 421. The VBA IDs are linked to virtual bank accounts created by the banking system 410 and allocated for the telco operator. The virtual bank accounts may be configured or provided for a specific transaction or type of transaction (e.g., paying a specific bill to the telco operator) and may correspond to the type of transaction associated with the billing accounts. The virtual bank accounts may be linked or mapped at the banking system 410 with at least one bank account associated with the telco operator (e.g., a deposit by a customer to a virtual bank account will ultimately deposit the money into the linked bank account of the telco operator).

The inventory management system 421 provides the list of VBA IDs to the BSS 423. The list of VBA IDs are then loaded into the VBA database 422. The VBA database 422 may be, e.g., a Structured Query Language (SQL) database or some other relational database. The VBA database 422 may include the VBA IDs, a status for the VBA (e.g., assigned, available, not assigned, not available, etc.), etc.

The BSS 423 maps (i.e., assigns) an available VBA ID from the list of VBA IDs to the billing account associated with a customer. The status of the VBA stored in the VBA database 422 may be changed/updated (by the BSS 423 and/or the inventory management system 421) from “available” to “assigned” based on its mapping to a billing account. If the customer has more than one billing account, a VBA ID is mapped to each of the billing accounts. According to one or more other embodiments, multiple billing accounts of the same customer may be mapped to the same VBA ID, or one billing or customer account may be mapped to a plurality of VBAs. The BSS 423 may also create a billing account for a new customer and assign an available VBA ID to the new billing account of the new customer. The BSS 423 transmits or stores the allocations (i.e., the associations between the VBA ID and the corresponding billing account) to/in the association database 424 where the association or mapping of the VBA ID and the billing account is stored. The association database 424 may be, e.g., a NoSQL database or some other cloud database utilized for storing the association information.

Moreover, each B2B customer is provided one or more VBAs allocated for bill payment. To make a payment, e.g., for a bill/invoice, the customer makes a payment to the VBA corresponding to the assigned VBA ID. Once the customer makes a successful payment (411) to the bank via the VBA, the banking system 410 sends a notification to the BSS 423. The notification is sent automatically or within a predetermined time soon after receipt of the payment. In some embodiments, the BSS 423 makes an API call for payment information. In response to the API call, the BSS 423 may receive the payment information including at least the payment amount and the VBA ID corresponding to the VBA in which the payment was made. As such, the telco operator (via the BSS 423) may be notified of the payment before a formal report is generated by the banking system 410.

In some embodiments, the BSS 423 may send an acknowledgement to the banking system 410 in response to the notification indicating that the payment information has been received. Further, an acknowledgement may also or alternatively be sent following a report or audit confirming that the payment is received as detailed in the payment information. That is, the payment amount actually received matches the banks records (i.e., the payment information) and the billing account credited value.

Upon receiving the notification, the BSS 423 updates the billing account (e.g., credits the billing account) associated with the VBA ID of the VBA in which the payment was received, based on the information stored in the association database 424. For example, the BSS 423, based on an API call, pulls the associated billing account from the association database 424 and credits the billing account. Therefore, because the virtual account is assigned to a single billing account allocated for a particular transaction and/or service provided, the telco operating system 420 is able to immediately (or within the predetermined time) reflect a processed payment made in a VBA to the appropriate billing account without requiring, e.g., an auditing process which is prone to error. In this manner, a bill is marked paid without delays caused by processing, account crediting, audit checks, balance checks, etc. These delays may be a combination of delays caused by, for example, the banking system 410 and/or the telco operator.

The VBA database 422 and the association database 424 may be internal or external to the telco operating system 420 and may be similar to or different from the storage component 340 of FIG. 3. In some embodiments, the VBA database 422 and the association database 424 comprise multiple data storages.

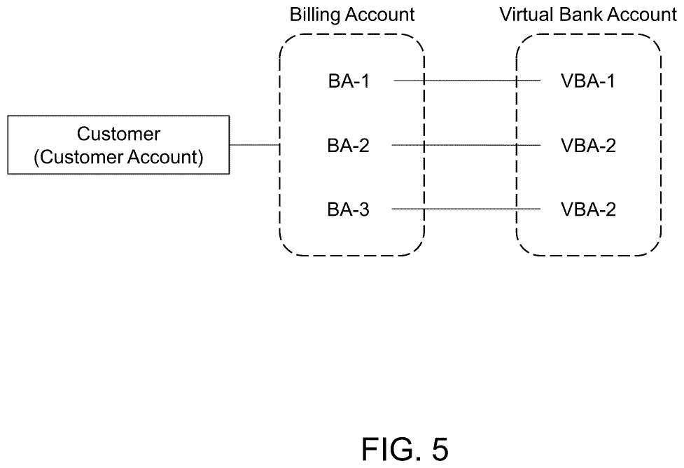

FIG. 5 is an illustration of associations made between VBA IDs and billing accounts, in accordance with one or more embodiments. For example, the BSS 423 of the telco operating system 420 described with reference to FIG. 4 follows the configuration as shown in FIG. 5. This configuration is not intended to limit the scope of embodiments. For example, a customer may only have one billing account or multiple VBAs may be mapped to one customer (i.e., a customer account).

According to embodiments, as shown in FIG. 5, there is a one-to-one VBA and billing account association within a customer account. That is, each virtual bank account is assigned to a billing account belonging to a customer of a B2B interaction. Based on the VBA ID and because each VBA is designated for a specific transaction, the bank and the telco operator is able to automatically determine which bill is paid (i.e., which billing account to credit) and confirm if the payment amount matches the bill amount.

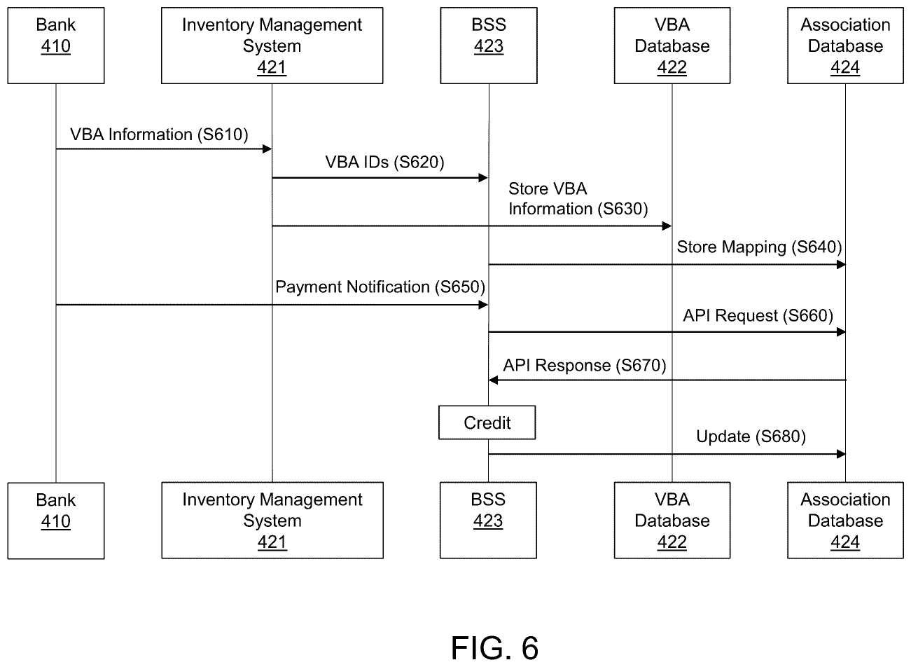

FIGS. 6-8 illustrate data and data flow of processes according to embodiments. FIG. 6 is a sequence diagram illustrating an example of a data flow in accordance with one or more embodiments.

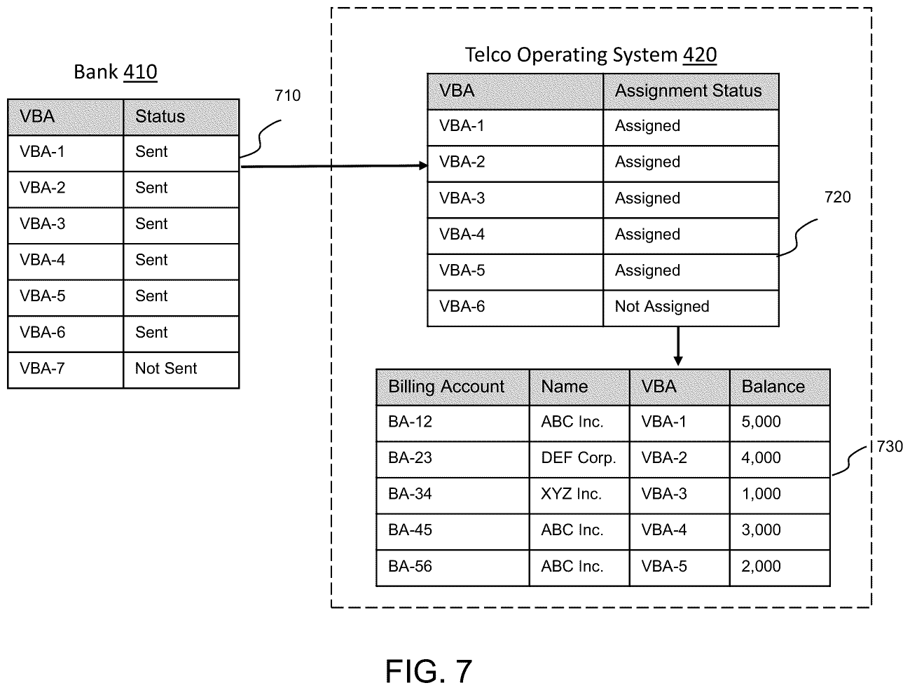

First, the banking system 410 (or a banking system) sends virtual bank account information to the inventory management system 421 of the telco operating system 420 (S610). The virtual bank account information may include at least a list of one or more VBA IDs and status of the of the corresponding VBA (e.g., sent, not sent, etc.). The status may be used as an acknowledgement from the banking system 410 indicating that the VBAs have been assigned to the telco operating system 420. In some embodiments, the status may not be shared with the telco operating system 420 and used merely by the banking system 410, e.g., for tracking purposes. An example of a table 710 containing the virtual bank account information is shown in FIG. 7.

Next, the inventory management system 421 transmits the available VBA IDs to the BSS 423 (S620). The inventory management system 421 also stores the virtual bank account information in the VBA database 422 (S630). The virtual bank account information may be stored with the VBA ID and the assignment status of the VBA (i.e., a status indicating which VBA IDs have been mapped to or associated with a billing account). An example of a table 720 containing the virtual bank account information and the assignment status stored in the VBA database 422 is shown in FIG. 7.

Upon receiving the available VBA IDs, the BSS 423 maps the VBA IDs to billing accounts corresponding to one to more customer accounts. The VBA to billing account mapping are then stored in the association database 424 (S640). FIG. 7 illustrates an example table 730 of the assignments as stored in the association database 424. As shown in FIG. 7, information such as the billing account (i.e., billing account ID), name of the corresponding customer account (e.g., ABC Inc., DEF Corp., and XYZ Inc.), the assigned VBA, and the bill balance are stored. One customer account may have multiple billing accounts and each of the billing accounts mapped to a VBA.

Next, as the banking system 410 receives payments from customers in the VBAs, the banking system 410 sends a notification to the BSS 423 (S650). As described, the notification indicates to the telco operating system 420 that a payment has been received at the banking system 410. Subsequently, based on the VBA ID of the VBA in which the payment was made, the BSS 423 makes an API request to pull the corresponding billing account (or billing account ID) from the association database 424 (S660). Next, the BSS 423 receives an API response including the billing account (S670). In some embodiments, the banking system 410 sends the notification in response to another API request from the telco operating system 420 (e.g., the BSS 423 to the baking system 410). The other API request may be made at various time intervals. Additionally, the banking system 410 may send the notification after every payment received, a group including a predetermined number of payments are received, or at various time intervals.

Lastly, the BSS 423 credits the billing account for the payment and updates the bill account balance in the association database 424 (S680).

Note that the steps in the sequence diagram described with reference to FIG. 6 are not intended to limit the configuration of data flow in embodiments. For example, one or more of the steps may be performed simultaneously.

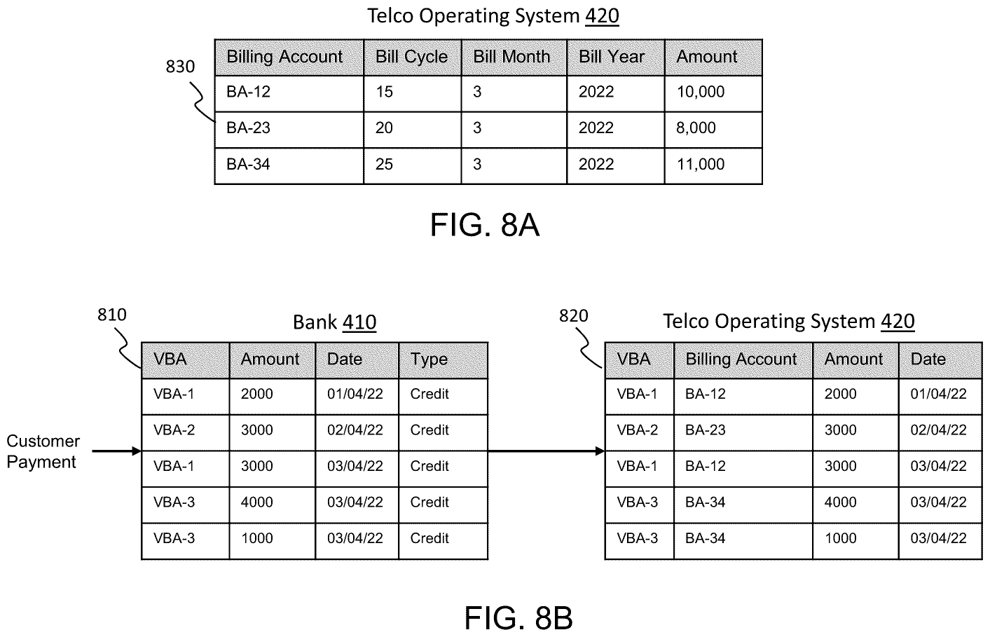

FIG. 8A is an example of a billing report 830 that may be generated before, after, or during the above described process by the telco operating system 420. The billing report 830 includes the billing account (or billing account ID), a bill cycle, billing month, billing year, and an amount of the bill/invoice associated with the billing account. The bill cycle maybe, e.g., a billing period or statement period (i.e., a time between two bill closing dates). At the end of a billing cycle, transactions from the billing period are added together and credited to the billing account.

FIG. 8B is an example of a payment report processed by the banking system 410 and the telco operating system 420. As described, the banking system 410 received customer payments in the VBAs. Payment report 810 is generated and transmitted by the banking system 410 to the telco operating system 420. The payment report 810 includes, e.g., VBA ID, amount, date, and type (e.g., credit or debit) for each of the payments received. The telco operating system 420 may also generate a payment report 820 including VBA information, the amount of the payment, and the date the payment was made. The payment amount is based on the payment report 810 received from the bank. The payment report 820 also includes a list of the correspond billing accounts. The payment report 820 may be used to check/confirm the accuracy of the credit in the billing account as reported by the banking system 410 (i.e., in the payment report 810), to compile a financial report, etc. Additionally, the payment report 820 may be used to update the billing account balance (as shown in table 730) in the association database 424.

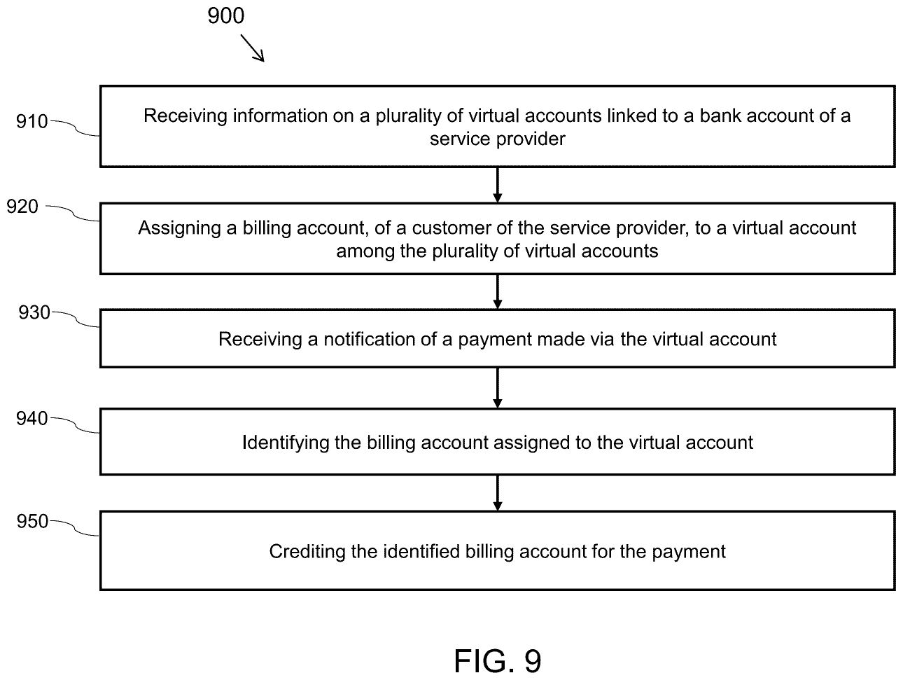

FIG. 9 is an exemplary flowchart illustrating a method 900, performed by at least one processor, for bill management of a B2B customer account, according to an embodiment. The B2B customer account may include one or more billing accounts, each of which are associated with a VBA.

In operation 910, the method 900 may include receiving a plurality of virtual bank accounts. The virtual bank accounts may be transmitted from a bank and may include, but is not limited to, virtual bank account ID.

In operation 920, the method 900 may include assigning the one or more billing accounts to the plurality of virtual bank accounts, wherein one of the one or more billing accounts is assigned to one of the plurality of virtual bank accounts. The method 400 may further include tracking a status of the plurality of virtual bank accounts (i.e., whether a virtual bank account is assigned or not assigned).

In operation 930, the method 900 may include receiving a notification of a payment made via the virtual account. The method 400 may further include transmitting an acknowledgment indicating the notification, including payment information, is successfully received.

In operation 940, the method 900 may include identifying the billing account (from among the one or more billing accounts) assigned to the virtual bank account.

Subsequently, in operation 950, the method 900 may include crediting the identified billing account for the payment. For example, the billing account may be credited by obtaining a total balance of the billing accounts and updating the total balance based on the payment.

Although FIG. 9 shows example operations of the method, in some implementations, the method may include additional operations, fewer operations, different operations, or differently arranged operations than those depicted in FIG. 9. Additionally, or alternatively, two or more of the operations of the method may be performed in parallel or combined.

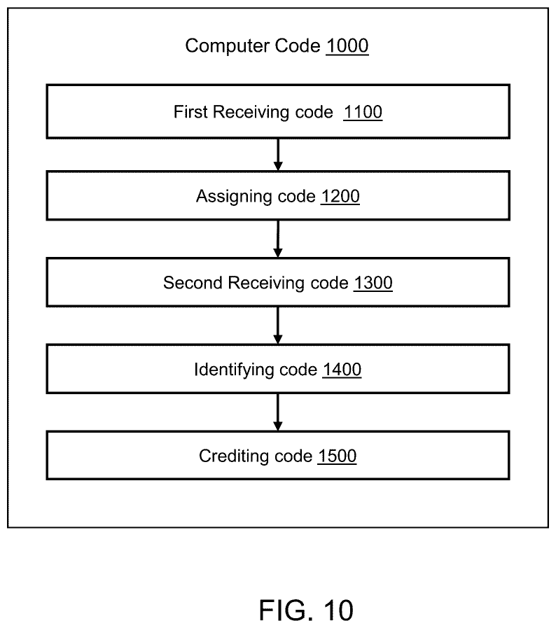

FIG. 10 is a block diagram of an example of computer code for bill management of a B2B customer account including one or more billing accounts, according an embodiment. According to embodiments of the present disclosure, an apparatus/device including at least one processor with memory storing computer code may be provided. The computer code may be configured to, when executed by the at least one processor, perform any number of aspects of the present disclosure.

As shown in FIG. 10, the computer code 1000 includes first receiving code 1000, assigning code 1200, second receiving code 1300, identifying code 1400, and crediting code 1500.

The receiving code 1100 is configured to cause the at least one processor to receive information on a plurality of virtual accounts. Here, the virtual bank account may be linked to a bank account of a service provider, and created and transmitted by a bank or the like.

The assigning code 1200 is configured to cause the at least one processor to assign a billing account, of a customer of the service provider, to a virtual account among the plurality of virtual accounts.

The receiving code 1300 is configured to cause the at least one processor to receive a notification of a payment made via the virtual account. The notification may include payment amount and the corresponding virtual bank account ID, as described above.

The identifying code 1400 is configured to cause the at least one processor to identify the billing account, from among the one or more billing accounts, assigned to the virtual account.

Lastly, the crediting code 1500 is configured to cause the at least one processor to crediting the billing account for the payment received.

Although FIG. 10 shows example blocks of the computer code 1000 of a system or apparatus according to embodiments, in some implementations, the system may include additional blocks, fewer blocks, different blocks, or differently arranged blocks than those depicted in FIG. 10. Additionally, or alternatively, two or more of the blocks of the system may be combined. In other words, while FIG. 10 shows distinct blocks of code, the various code instructions need not be distinct and could be intermingled.

Embodiments of the present disclosure relate to a bill management method and apparatus that provides B2B customers with a dedicated virtual bank account mapped to one billing account. The method and apparatus advantageously eliminate the need for manual intervention when a payment is made resulting in a more efficient payment process, reduction of human errors (more accurate auditing results), low chance of revenue leakage, and simpler and clearer bill management with lower management costs.

The one-to-one virtual bank account to billing account relationship is beneficial because it does not require an auditing process for confirming amount, customer, and/or billing account and waiting an extended period of time wherein a customer may be barred or suspended from services. Embodiments avoid delay time caused by a bank's review/audit process for an invoice in order to properly credit an account. The bank may still perform the review/audit. However, using the bill management system according to embodiments, the status of the billing account will reflect a paid/accredited bill (i.e., not unpaid) before, e.g., the auditing process is completed and/or initiated. As such, if the due date of a bill is on the same day a payment is made, the customer will not suffer the consequences (i.e., barring and/or service suspension) of an extended auditing process before a billing account is credited. If after the bank performs the audit and an error is discovered, the customer may still be barred or suspended. The bill management system and method described herein reduces the chances of a customer being barred prematurely.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method for bill management of a business to business (B2B) customer account comprising one or more billing accounts, performed by at least one processor and comprising:
receiving information on a plurality of virtual accounts linked to a bank account of a service provider;
assigning a billing account, of a customer of the service provider, to a virtual account among the plurality of virtual accounts;
receiving a notification of a payment made via the virtual account;
identifying the billing account, from among the one or more billing accounts, assigned to the virtual account; and
crediting the identified billing account for the payment.

2. The method of claim 1, further comprising:
transmitting an acknowledgment indicating at least one of a payment successfully received or a payment credited to a billing account.

3. The method of claim 1, further comprising:
storing a status of each of the plurality of virtual accounts, the status being at least one of assigned or not assigned.

4. The method of claim 1, further comprising:
obtaining a total balance of the billing account and crediting the billing account by updating the total balance based on the payment.

5. The method of claim 1, further comprising:
receiving a payment report indicating payments made to the plurality of virtual accounts, amounts of the payments, and dates the payments were received.

6. The method of claim 1, further comprising:
generating a bill report indicating a billing cycle, billing year, billing month, and bill amount corresponding to the billing account.

7. The method of claim 1, wherein the notification includes at least a payment amount of the payment and an identification corresponding to the virtual account.

8. An apparatus for bill management of a business to business (B2B) customer account comprising one or more billing accounts, the apparatus comprising:
at least one memory configured to store program code; and
at least one processor configured to read the program code and operate as instructed by the program code, the program code configured to case the at least one processor to:
receive information on a plurality of virtual accounts linked to a bank account of a service provider;
assign a billing account, of a customer of the service provider, to a virtual account among the plurality of virtual accounts;
receive a notification of a payment made the virtual account;
identify the billing account, from among the one or more billing accounts, assigned to the virtual account; and
credit the identified billing account for the payment.

9. The apparatus of claim 8, wherein the at least one processor is configured to read the program code and operate as instructed by the program code to transmit an acknowledgment indicating at least one of payment information successfully received, via the notification, or a payment credited to a billing account.

10. The apparatus of claim 8, wherein the at least one processor is configured to read the program code and operate as instructed by the program code to store a status of each of the plurality of virtual accounts, the status being at least one of assigned or not assigned.

11. The apparatus of claim 8, wherein the at least one processor is configured to read the program code and operate as instructed by the program code to obtain a total balance of the billing account and credit the billing account by updating the total balance based on the payment.

12. The apparatus of claim 8, wherein the at least one processor is configured to read the program code and operate as instructed by the program code to receive a payment report indicating payments made to the plurality of virtual accounts, amounts of the payments, and dates the payments were received.

13. The apparatus of claim 8, wherein the at least one processor is configured to read the program code and operate as instructed by the program code to generate a bill report indicating a billing cycle, billing year, billing month, and bill amount corresponding to the billing account.

14. The apparatus of claim 8, wherein the notification includes at least a payment amount of the payment and an identification corresponding to the virtual account.

15. A non-transitory computer readable medium storing instructions that, when executed by at least one processor of an apparatus for bill management of a business to business (B2B) customer account comprising one or more billing accounts, cause the at least one processor to:
receive information on a plurality of virtual accounts linked to a bank account of a service provider;
assign a billing account, of a customer of the service provider, to a virtual account among the plurality of virtual accounts;
receive a notification of a payment made via the virtual account;
identify the billing account, from among the one or more billing accounts, assigned to the virtual account; and
credit the identified billing account for the payment.

16. The non-transitory computer readable medium of claim 15, wherein the instructions further cause the at least one processor to transmit an acknowledgment indicating at least one of payment information successfully received, via the notification, or a payment credited to a billing account.

17. The non-transitory computer readable medium of claim 15, wherein the instructions further cause the at least one processor to store a status of each of the plurality of virtual accounts, the status being at least one of assigned or not assigned.

18. The non-transitory computer readable medium of claim 15, wherein the instructions further cause the at least one processor to obtain a total balance of the billing account and credit the billing account by updating the total balance based on the payment.

19. The non-transitory computer readable medium of claim 15, wherein the instructions further cause the at least one processor to receive a payment report indicating payments made to the plurality of virtual accounts, amounts of the payments, and dates the payments were received.

20. The non-transitory computer readable medium of claim 15, wherein the instructions further cause the at least one processor to generate a bill report indicating a billing cycle, billing year, billing month, and bill amount corresponding to the billing account.
